(19) United States
(12) Patent Application Publication
(10) Pub. No.: US 2010/0145612 A1
(43) Pub. Date: Jun. 10, 2010

(54) NAVIGATION DEVICE AND METHOD

(75) Inventors: WANG-CHANG DUAN, Shenzhen City (CN); BANG-SHENG ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/610,374

(22) Filed: Nov. 2, 2009

(30) Foreign Application Priority Data
Dec. 4, 2008 (CN) 200810305961.8

(51) Int. Cl. G01C 21/00; G01C 21/32

(52) U.S. Cl. 701/208; 701/220

(57) ABSTRACT

A navigation device includes a receiving unit, a positioning unit, a memory, a orientation detector, a processor, and a display. The receiving unit is used for receiving positioning signals. The positioning unit computes current positioning information of the navigation device according to the positioning signals. The memory is used for storing an electronic map. The orientation detector is used for detecting a turned angle and a turned direction of the navigation device. The processor is used for obtaining the electronic map from the memory and rotating the electronic map according to the turned angle and the turned direction. The display unit is used for displaying the rotated electronic map and the current positioning information of the navigation device on the rotated electronic map.

### BACKGROUND 1. Technical Field

The present disclosure relates to navigation, and particularly to a navigation device and method.

2. Description of Related Art

Navigation devices are becoming more and more prevalent. Via built-in map data for route planning, a navigation device display electronic maps and provides indication directions to enable a user to arrive at a desired destination.

However, directions of the electronic maps are not changed according to direction changes of the navigation device, the user need to change the indication directions to actual directions via comparing road environment displayed on the navigation device with actual environment. This is inconvenient. Therefore, improved navigation devices and methods are desired.

### BRIEF DESCRIPTION OF THE DRAWINGS

FIG. 1 is a block diagram of a navigation device in accordance with an exemplary embodiment.

FIG. 2 is a first schematic view of an electronic map used in the navigation device of FIG. 1.

FIG. 3 is a second schematic view of the electronic map used in the navigation device of FIG. 1.

FIG. 4 is a flowchart of a navigation method in accordance with an exemplary embodiment.

### DETAILED DESCRIPTION

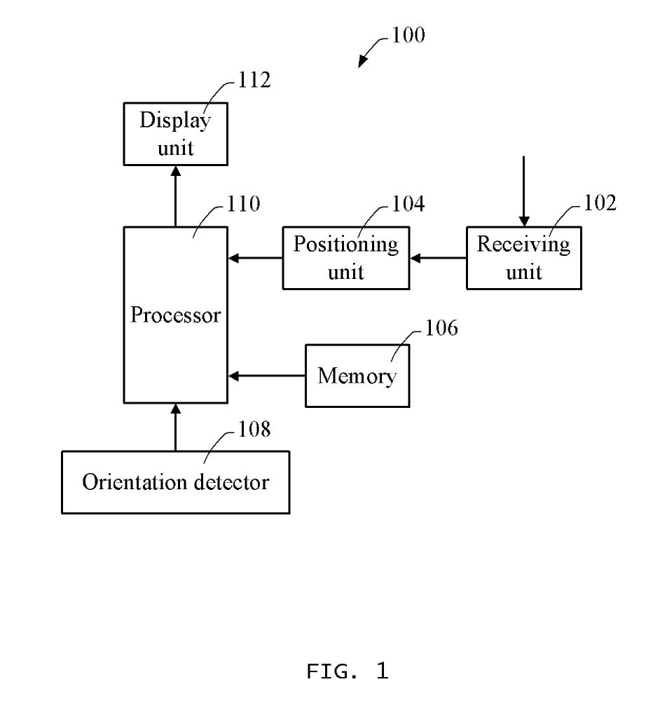

Referring to FIG. 1, a navigation device 100 includes a receiving unit 102, a positioning unit 104, a memory 106, an orientation detector 108, a processor 110, and a display unit 112.

The receiving unit 102 is used for receiving positioning signals, the positioning signals may be transmitted by global positioning system (GPS) satellites.

The positioning unit 104 is used for computing current positioning information of the navigation device 100 according to the positioning signals.

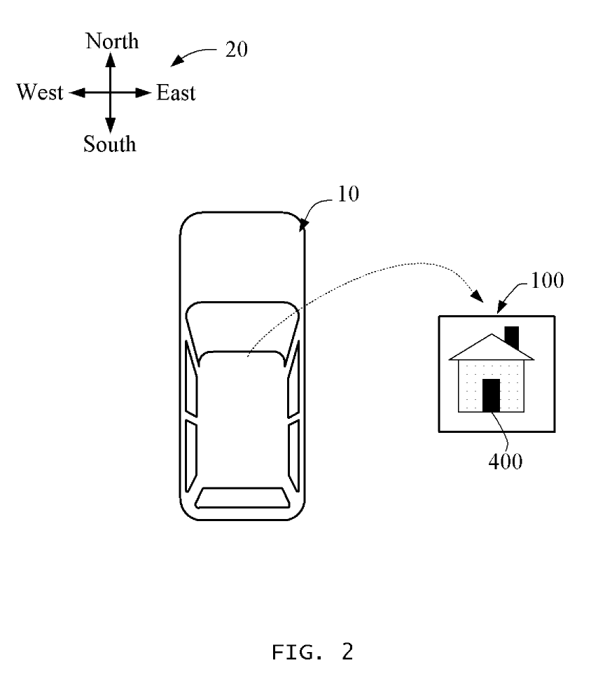

The memory 106 is used for storing an electronic map 400 (referring to FIG. 2).

The orientation detector 108 is used for detecting a turned angle and a turned direction of the navigation device 100. When the navigation device 100 is adopted in a vehicle, the orientation detector 108 detects the turned angle and turned direction of the vehicle. The turned direction may be clockwise or counter-clockwise. The orientation detector 108 may be an accelerometer or an electronic compass or others. When the orientation detector 108 is an accelerometer, the orientation detector 108 detects the turned angle and the turned direction by detecting centrifugal forces of the navigation device 100 when the navigation device 100 turns. When the orientation detector 108 is an electronic compass, the orientation detector 108 detects the turned angle and the turned direction by detecting changes in the earth magnetic field.

The processor 110 is used for obtaining the electronic map 400 from the memory 106, and rotating the electronic map 400 according to the turned angle and the turned direction of the navigation device 100. It is understood that a rotation direction of the electronic map 400 is opposite to the turned direction of the navigation device 100; a rotation angle of the electronic map 400 is substantially equal to the turned angle of the navigation device 100.

The display unit 112 is used for displaying the rotated electronic map 400 and a position indicator on the electronic map according to the current positioning information of the navigation device 100.

In use, when the orientation detector 108 is an accelerometer, the user may need to manually adjust orientation of the electronic map 400 before using the navigation device 100. When the orientation detector 108 is an electronic compass, the electronic compass can be appropriately configured to automatically adjust directions of the electronic map 400.

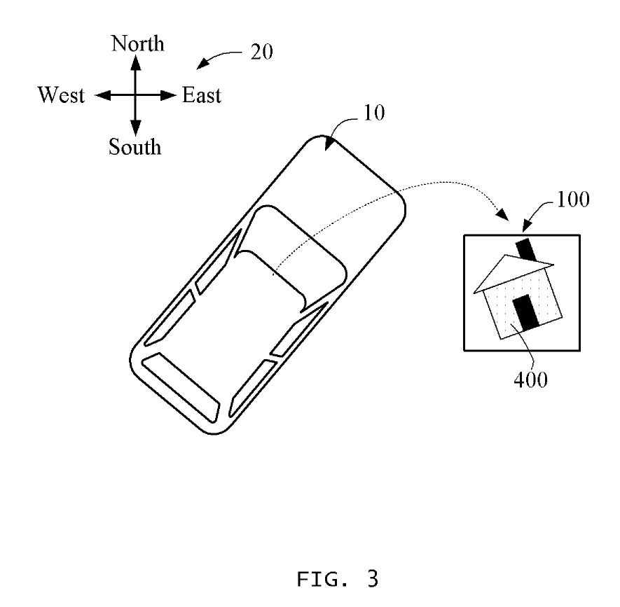

Referring to FIGS. 2 and 3, the navigation device 100 is arranged in a vehicle 10 used as an example for illustration. The orientation of the vehicle 10 and the navigation device 100 are opposite. When the vehicle 10 turns right from north to northeast, that is, the vehicle 10 rotates clockwise 45 degrees, the electronic map 400 rotates counter-clockwise rotates 45 degrees. Therefore, road environment displayed on the navigation device 100 are substantially the same with actual environment. It is convenient to use the 100 to navigate to a destination position.

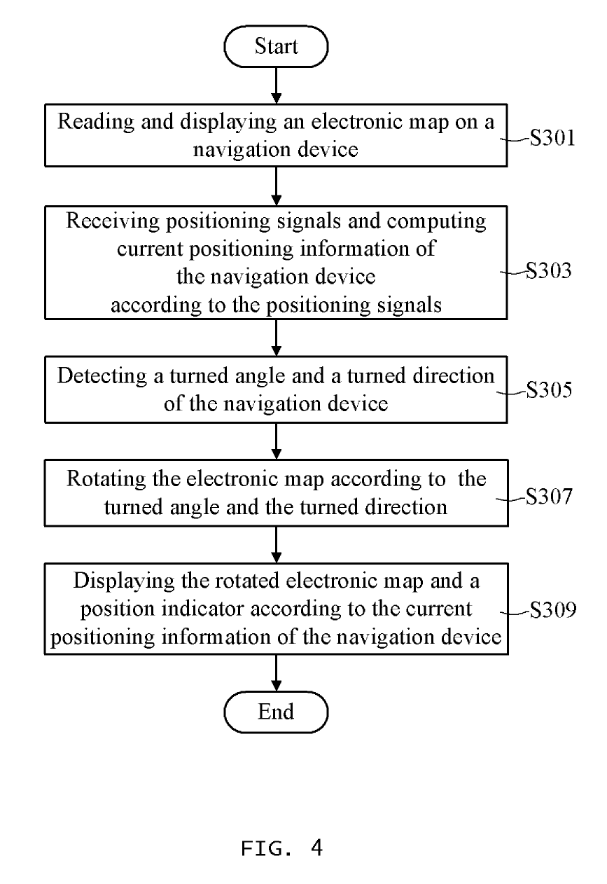

Referring to FIG. 4, a navigation method in accordance with an exemplary embodiment is illustrated includes following steps. The navigation method may be implemented using the navigation 100 (FIG. 1).

In step S301, reading and displaying an electronic map on a navigation device.

In step S303, receiving position signals and computing current positioning information according to the positioning signals. The positioning signals may be transmitted by global positioning system (GPS) satellites.

In step S305, detecting a turned angle and a turned direction of the navigation device. The turned angle and the turned direction may be detected by an accelerometer or an electronic compass or others. The turned direction may be clockwise or counter-clockwise.

In step S307, rotating the electronic map according to the turned angle and the turned direction of the navigation device. It is understood that a rotation direction of the electronic map is opposite to the turned direction of the navigation device 100, a rotation angle of the electronic map is substantially equal to the turned angle of the navigation device 100.

In step S309, displaying the rotated electronic map and an position indicator according to the current positioning information of the navigation device.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A navigation device, comprising:
a receiving unit for receiving positioning signals;
a positioning unit configured to compute current positioning information of the navigation device according to the positioning signals;
a memory for storing an electronic map;
an orientation detector for detecting a turned angle and a turned direction of the navigation device;
a processor for obtaining the electronic map from the memory and rotating the electronic map according to the turned angle and the turned direction; and
a display unit for displaying the rotated electronic map and the current positioning information of the navigation device on the rotated electronic map.

2. The navigation device according to claim 1, wherein a rotation direction of the electronic map is opposite to the turned direction of the navigation device; and a rotation angle of the electronic map is equal to the turned angle of the navigation device.

3. The navigation device according to claim 2, wherein the turned direction is one of clockwise and counter-clockwise.

4. The navigation device according to claim 1, wherein the orientation detector is an accelerometer, the accelerometer detects the turned angle and the turned direction by detecting centrifugal forces of the navigation device.

5. The navigation device according to claim 1, wherein the orientation detector is an electronic compass, the orientation detector detects the turned angle and the turned direction by detecting changes in the earth magnetic field.

6. A navigation method, comprising:
receiving and displaying an electronic map on a navigation device;
receiving positioning signals and computing current positioning information of the navigation device;
detecting a turned angle and a turned direction of the navigation device;
rotating the electronic map according to the turned angle and the turned direction; and
displaying the rotated electronic map and a position indicator according to current positioning information of the navigation device on the rotated electronic map.

7. The navigation method according to claim 6, wherein a rotation direction of the electronic map is opposite to the turned direction of the navigation device, a rotation angle of the electronic map is equal to the turned angle of the navigation device.

8. The navigation method according to claim 6, wherein the turned angle and the turned direction are detected by an accelerometer via detecting centrifugal forces of the navigation device.

9. The navigation method according to claim 6, wherein the turned angle and the turned direction are detected by the electronic compass via detecting changes in the earth magnetic field.

10. The navigation method according to claim 6, wherein the turned direction is one of clockwise and counter-clockwise.
